(19) United States
(12) Patent Application Publication
(10) Pub. No.: US 2014/0056794 A1
(43) Pub. Date: Feb. 27, 2014

(54) METHOD FOR TREATING EXHAUST GAS CONTAINING INORGANIC HALOGENATED GAS

(71) Applicant: Ebara Corporation, Tokyo (JP)

(72) Inventor: Yoichi MORI, Tokyo (JP)

(73) Assignee: EBARA CORPORATION, Tokyo (JP)

(21) Appl. No.: 13/970,746

(22) Filed: Aug. 20, 2013

(30) Foreign Application Priority Data
Aug. 24, 2012 (JP) 2012-185428
Feb. 26, 2013 (JP) 2013-035951

(51) Int. Cl. B01J 41/14; B01D 53/68

(52) U.S. Cl. CPC B01J 41/14; B01D 53/685
USPC 423/241; 423/240 S; 521/32

(57) ABSTRACT

A method for treating exhaust gas, comprising first contacting exhaust gas comprising inorganic halogenated gas discharged from sources of the exhaust gas with Fe₂O₃ or synthetic zeolite and then contacting with an anion exchange resin having water content of 5 w/w % or less and halogen content of 10 mg/g or less.

### TECHNICAL FIELD

The present invention relates to a method or apparatus for treating exhaust gas containing inorganic halogenated gas. Such exhaust gas is discharged, for example, when the internal surface and the like of semiconductor-manufacturing equipment are dry-cleaned.

### BACKGROUND ART

Exhaust gas discharged from semiconductor-manufacturing equipment (a step of dry etching or cleaning) contains hazardous gases such as ClF₃, SiF₄, SiCl₄, SiBr₄, BF₃, BCl₃, PF₃, PCl₃, HF, HCl, HBr, F₂, Cl₂ and Br₂, which are inorganic halogenated gases. The present inventors proposed a dry treatment method using a solid chemical as a method for treating inorganic halogenated gases including those hazardous gases (Patent Document 1). In the dry treatment method, an exhaust gas containing inorganic halogenated gas is first contacted with Fe₂O₃ or synthetic zeolite and then contacted with an anion exchange resin containing at most 5% water, thereby adsorbing the inorganic halogenated gas on the anion exchange resin and removing the inorganic halogenated gas.

### CITATION LIST

### Patent Document

Patent Document 1: Japanese Patent No. 3981206

### SUMMARY OF INVENTION

### Technical Problem

The adsorption performance of anion exchange resins is evaluated in terms of their ion exchange capacity. Ion exchange capacity is determined based on the amount of the functional group contained in an ion exchange resin and can be restored to a level equivalent to that of a new product by regeneration treatment. However, in treatment of exhaust gas containing inorganic halogenated gas, cases arise where ion exchange resins having sufficient ion exchange capacity exhibit insufficient performance for adsorbing and removing the inorganic halogenated gas. This revealed that evaluations of only ion exchange capacity are insufficient.

The present invention aims to provide a method for treating exhaust gas containing inorganic halogenated gas using an appropriate anion exchange resin.

### Solution to Problem

As a result of extensive and intensive studies on anion exchange resins that can be appropriately used for treatment of exhaust gas containing inorganic halogenated gas, the present inventors newly found that the adsorption performance of anion exchange resins is strongly affected by not only their ion exchange capacity and water content but also their halogen content. This finding led to the completion of the present invention.

According to the present invention, there is provided a method for treating exhaust gas containing inorganic halogenated gas which is characterized by use of an anion exchange resin with water content of 5 w/w % or less and halogen content of 10 mg/g or less.

Specifically, exhaust gas comprising inorganic halogenated gas discharged from sources of the exhaust gas, is first contacted with Fe₂O₃ or synthetic zeolite and then contacted with an anion exchange resin having water content of 5 w/w % or less and halogen content of 10 mg/g or less, thereby adsorbing the inorganic halogenated gas on the anion exchange resin and removing the inorganic halogenated gas.

It is appropriate that the inorganic halogenated gas is chlorine trifluoride (ClF₃), silicon tetrahalide (SiX₄), boron trihalide (BX₃), phosphorus trihalide (PX₃), hydrogen halide (HX), or halogen gas (X₂) wherein X is a halogen atom. Specifically, the inorganic halogenated gas may preferably include ClF₃, SiF₄, SiCl₄, BF₃, BCl₃, PF_{S}, PCl_{S}, HF, HCl, HBr, Cl₂, F₂ and Br₂, more preferably ClF₃.

The anion exchange resin is preferably a weakly basic anion exchange resin, more preferably an anion exchange resin comprising a skeleton of a styrene-divinylbenzene copolymer and an anion exchange group attached to a benzene ring of the styrene moiety and divinylbenzene moiety of the copolymer. Examples of the anion exchange group include amino groups represented by the following formula:

—N(R₁)(R₂) [Formula 1]

wherein each of R₁ and R₂, which may be the same or different, is a hydrogen atom or a Cᵢ₋₆ alkyl group that may be substituted with an amino group(s) or a hydroxyl group(s); each of R₁ and R₂, which may be the same or different, is preferably a C₁₋₃ alkyl group, more preferably a methyl group.

The anion exchange resin may be a common marketed product, but is used after adjustment of its water and halogen contents to those within the ranges defined in the present invention. The halogen content may be adjusted by washing of the anion exchange resin with washing water having chlorine content of 20 mg/L or less so that the halogen content reaches 10 mg/g or less. The adjustment may be generally achieved by washing with washing water having a volume that is 20- to 40-times the volume of the anion exchange resin. Meanwhile, the water content may be adjusted by drying of the anion exchange resin for approximately 8 to 12 hours at a temperature of 100° C., at which the resin is not thermally degraded. The anion exchange resin may be a new product or a regenerated product, and may be regenerated using an alkali aqueous solution and washing water having chlorine content of 20 mg/L or less. Especially, weakly basic anion exchange resins are more easily regenerated than strongly basic anion exchange resins and can be regenerated using a small volume of an alkali aqueous solution.

### Advantageous Effects of Invention

In accordance with the present invention, inorganic halogenated gas, for example, ClF₃ and gases discharged as by-products can be effectively removed. Further, the present invention can provide an anion exchange resin having great capacity to treat inorganic halogenated gas. Further, the method of the present invention can prolong the lifespan of anion exchange resins.

### BRIEF DESCRIPTION OF DRAWINGS

FIG. 1 is a sectional view showing one embodiment of the apparatus of the present invention.

FIG. 2 is a sectional view showing another embodiment of the apparatus of the present invention.

FIG. 3 is a graph showing the relation between the residual chlorine content in the anion exchange resins and the treated amount of Cl₂.

FIG. 4 is a graph showing the relation between the chlorine concentration in washing waters and the residual chlorine concentration in resins.

### DESCRIPTION OF EMBODIMENTS

Hereinafter, the present invention will be described in more detail with reference to attached drawings, but the scope of the present invention is not limited thereto.

In accordance with the method of the present invention, first of all, exhaust gas containing inorganic halogenated gas is contacted with a treatment agent that is an iron oxide (Fe₂O₃) or synthetic zeolite, to thereby fix the inorganic halogenated gas, for example, as a fluoride or chloride, to the treatment agent.

ClF₃, if taken as an illustrative example of the inorganic halogenated gas, reacts with an iron oxide such as Fe₂O₃, as shown by the following formula:

3ClF₃+2Fe₂O₃→3FeF₃+FeCl₃+3O₂ [Formula 2]

Likewise, ClF₃ reacts with the Al₂O₃ moiety of synthetic zeolite, as shown by the following formula:

3ClF₃+2Al₂O₃→3AlF₃+AlCl₃+3O₂ [Formula 3]

In accordance with these reaction formulae, the fluorine atoms of the chlorine trifluoride are fixed as an iron fluoride (FeF₃) or an aluminum fluoride (AlF₃). However, the chlorine atoms of the chlorine trifluoride are not only fixed as FeCl₃ or AlCl₃ but also released as gaseous Cl₂. Part of the Cl₂ is also reacted with an iron oxide or synthetic zeolite and adsorbed thereon; however, since their capability to treat Cl₂ is low, a large portion of the Cl₂ leaks from the treatment agents earlier than ClF₃ or other inorganic halogenated gases.

Likewise, boron trihalide (BX₃, wherein X is a halogen atom, in particular, a fluorine atom, a chlorine atom or a bromine atom) is removed by an iron oxide or synthetic zeolite. However, most of halogen gas (X₂) generated as a by-product is discharged from an iron oxide or synthetic zeolite.

In the method of the present invention, the halogen gas (X₂) (e.g., Cl₂) which is not removed by an iron oxide or synthetic zeolite but is discharged, is removed through contact for reaction with an ion exchange resin that can remove halogen gases, such as an anion exchange resin. An example of this reaction is shown as follows:

X₂+(R₁) (R₂) (R₃) N →[(R₁) (R₂) (R₃) N]+·X^{.X}⁻ [Formula 4]

wherein each each of R₁, R₂ and R₃, which may be the same or different, is a hydrogen atom or a C₁₋₆ alkyl group that may be substituted with an amino group(s) or a hydroxyl group(s), or each of R₁, R₂ and R₃ is a C₆₋₁₄ aryl group which may be a repeating unit or part of a repeating unit, in a polymer chain; X is a halogen atom.

Examples of the inorganic halogenated gas that can be adsorbed and removed by the treatment method of the present invention may include chlorine trifluoride (ClF₃), silicon tetrahalide (SiX₄), boron trihalide (BX₃), phosphorus trihalide (PX₃), hydrogen halide (HX), halogen gas (X₂) and the like, wherein X is a halogen atom. The term “halogen atom” as used herein refers to a fluorine atom, a chlorine atom, a bromine atom or an iodine atom, and the halogen atom is preferably a fluorine atom, a chlorine atom or a bromine atom. SiX₄, if taken as an example of the inorganic halogenated gas, may also be a mixture of two or more halogen atoms, such as SiF₃Cl, SiF₂Cl₂, SiFCl₃, SiFClBr₂ or SiFClBrI. Likewise, for example, BX₃ may be BF₂Cl, BFCl₂, BFClBr or the like. The inorganic halogenated gas as mentioned herein preferably includes ClF₃, SiF₄, SiCl₄, BF₃, BCl₃, PF₃, PCl₃, HF, HCl, HBr, Cl₂, F₂ and Br₂, more preferably ClF₃.

The treatment agent that can be used in the present invention is an iron oxide or zeolite. The iron oxide comprises primarily trivalent iron oxide (Fe₂O₃). The zeolite is preferably synthetic zeolite containing a high volume of aluminum. Relative to 1 part by mole of Al₂O₃, preferably 0.5 to 10 parts by mole of SiO₂, more preferably 1 to 5 parts by mole of SiO₂, still more preferably 2.5 parts by mole of SiO₂ is contained. For example, the zeolite having the chemical formula Na₂O.Al₂O₃.2.5SiO₂ is used. The sodium oxide in this zeolite may be substituted with another alkali metal such as potassium or an alkaline earth metal such as calcium. A zeolite that is used in the present invention preferably has, for example, an average pore size of 10 Å and a specific surface area of 650 m²/g.

Next, appropriate apparatuses for implementing the treatment method of the present invention will be described.

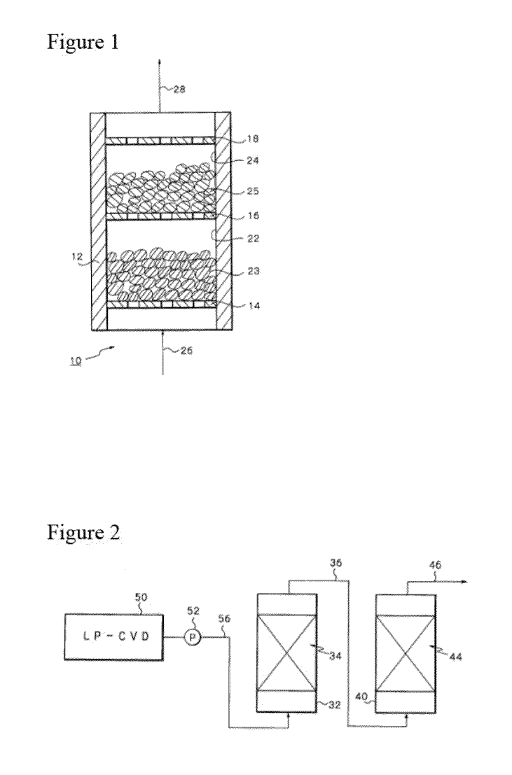

FIG. 1 illustrates a treatment apparatus 10 in which two packed beds are arranged within one packed column. The apparatus 10 has a packed column 12, the inside of which is partitioned with partition plates 14, 16 and 18. The partition plates 14, 16 and 18 each have a hole, through which exhaust gas can pass. The partition plates 14 and 16 define a first compartment 22 and the partition plates 16 and 18 define a compartment 24. Within the compartment 22, a packed bed 23 is located which comprises an iron oxide or synthetic zeolite. Likewise, the compartment 24 is located downstream of the compartment 23 and a packed bed 25 is located within the compartment 24. The packed bed 25 comprises an anion exchange resin whose water content has been adjusted to 5 w/w % or less and halogen content to 10 mg/g or less.

The shapes of the iron oxide or synthetic zeolite and predetermined ion exchange resin which constitute the packed beds 23 and 25, respectively, are not limited in any case but are, for example, a granule-like/rod-like or plate-like shape, as long as good operability is ensured. It is preferred that the particle size of these treatment agents is small to keep a larger contact area, as long as airflow resistance does not increase upon the passing of exhaust gas; the particle size is desirably 7 to 16 meshes for the iron oxide, 14 to 20 meshes for the synthetic zeolite, and 20 to 50 meshes for the anion exchange resin.

The exhaust gas comprising inorganic halogenated gas is introduced into the apparatus 10 from an inlet 26. The gas is first contacted with the packed bed 23 which comprises an iron oxide or synthetic zeolite. Next, the gas is contacted with the packed bed 25 which comprises an anion exchange resin, and then discharged from the apparatus 10 via an outlet 28.

The packed beds 23 and 25 do not need heating, because the apparatus 10 is typically heated by a chemical reaction in the packed bed 23 even when gas kept at room temperature is introduced into the apparatus 10. For example, the temperature of the packed bed 23 reaches approximately 200° C. in some cases.

In the treatment apparatus illustrated by FIG. 1, the exhaust gas flows up from the lower part of the apparatus 10 to the upper part. However, the exhaust gas may also flow down from the upper part of the apparatus 10 to the lower part. In the latter case, it is necessary to reverse the order of the packed beds.

FIG. 2 illustrates a treatment apparatus 30 in which two packed columns are provided, each of which has one packed bed located in the each column. The apparatus 30 has packed columns 32 and 40 and a connection 36 which connects the columns. Within each of the packed columns 32 and 40, packed beds 34 and 44, respectively, are located. The packed bed 34 comprises an iron oxide or synthetic zeolite. The packed bed 44 comprises an anion exchange resin whose water content has been adjusted to 5 w/w % or less and halogen content to 10 mg/g or less.

A semiconductor-manufacturing equipment 50, such as chemical vapor deposition equipment, produces exhaust gas containing inorganic halogenated gas. The exhaust gas is introduced via a connection 56 into the packed column 32, and first contacted with the packed bed 34, which comprises an iron oxide or synthetic zeolite. The exhaust gas is then introduced via the connection 36 into the packed column 40. The exhaust gas is contacted with the packed bed 44, which comprises an anion exchange resin, and then discharged via an outlet 46 from the apparatus 30.

### EXAMPLES

The present invention will be specifically described by means of examples, but the scope of the present invention is not limited thereto.

[The Amount of Residual Chlorine in the Anion Exchange Resins and the Amount of Treated Halogenated Gas]

The anion exchange resins having a skeleton comprising a styrene-divinylbenzene copolymer and a dimethylamino group attached to a benzene ring of the styrene moiety and divinylbenzene moiety of the copolymer was washed with any of washing waters having different chlorine contents, and then dried at 100° C. for 6 hours to prepare seven samples having water content of 5 w/w % or less and differed in chlorine content.

100 ml each sample was packed into a hollow cylindrical minicolumn (inside diameter 40 mm and height 250 mm), through which Cl₂ gas (1 vol./vol. % conc.) was passed at 500 ml/min. From the total volume of the gas passed until Cl₂ was detected at the outlet at an acceptable concentration (0.5 ppm as Cl₂), the volume of Cl₂ treated per liter of the each ion exchange resin (L/L) was calculated.

Further, 100 ml each of Sample No. 1 (chlorine content: 5.0 mg/g), Sample No. 3 (chlorine content: 13 mg/g) and Sample No. 7 (chlorine content: 85 mg/g) was packed into a hollow cylindrical minicolumn (inside diameter 40 mm and height 250 mm), through which Br₂ gas (0.50% conc.) was passed at 300 ml/min. From the total volume of the gas passed until Br₂ was detected at the outlet at an acceptable concentration (0.1 ppm as Br₂), the volume of Br₂ treated per liter of the each ion exchange resin (L/L) was calculated.

The water content was calculated from the rate of weight reduction after drying 2 g each of the samples at 105±2° C. for 2.5 hours.

The chlorine content was measured by immersing 1 g each of the samples in 100 ml of a 0.5% NaOH solution, allowing the samples to stand still overnight to elute Cl⁻ ions, and quantifying the Cl⁻ ions in the solution using an ion chromatograph.

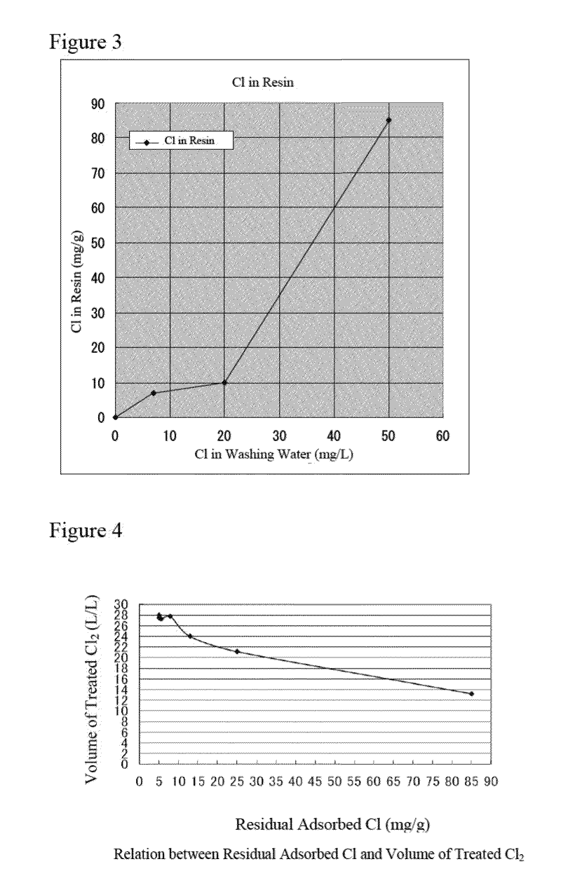

The results of measurement of residual chlorine in the anion exchange resins washed with washing waters having different chlorine concentrations are shown in Table 1 and FIG. 3. FIG. 3 reveals that the anion exchange resins contained at most 10 mg of residual chlorine per gram as a result of being washed with washing waters having a chlorine concentration of at most 20 mg/L.

The results of measurement of treated amounts of Cl₂ and treated Br₂ using seven anion exchange resins containing chlorine in different volumes are shown in Table 1 and the relation between the amount of residual chlorine in the anion exchange resins and the treated amounts of Cl₂ are shown in FIG. 3.

TABLE 1
Anion exchange resin samples

| | | | Volume | Volume of |
|---|---|---|---|---|
| Sample | Water content | Chlorine content | of treated Cl₂ | treated Br₂ |
| No. | (w/w %) | (mg/g) | (L/L) | (L/L) |
| 1 | 3.9 | 5.0 | 28.0 | 58.0 |
| 2 | 3.8 | 5.1 | 27.5 | — |
| 3 | 4.2 | 5.6 | 27.3 | 55.0 |
| 4 | 1.9 | 7.9 | 27.8 | — |
| 5 | 2.1 | 13 | 24.0 | — |
| 6 | 2.9 | 25 | 21.2 | — |
| 7 | 3.0 | 85 | 13.3 | 46.0 |

It could be confirmed that there was no difference in the volume of treated Cl₂ at a chlorine content of 7.9 mg/g or lower while the volume of treated Cl₂ decreased in inverse proportion to the chlorine content at a chlorine content of more than 10 mg/g. The same tendency was observed for the volume of treated Br₂.

[Treatment of Exhaust Gas Comprising Inorganic Halogenated Gas]

Sample No. 1 was packed into the treatment apparatuses illustrated by FIG. 1 and exhaust gas comprising inorganic halogenated gas was treated with the apparatuses. As the packed columns 12, cylindrical polytetrafluoroethylene (Teflon (registered trademark)) containers having an inside diameter of 40 mm were used. Fe₂O₃ or synthetic zeolite was packed as the packed bed 23 at the first stage so that the packed bed had a height of 72 mm. Further, an anion exchange resin (Sample No. 1) was packed into each apparatus as the packed bed 25 at the second stage so that the packed bed had a height of 72 mm. The Fe₂O₃ used is a granule-like marketed product having a particle size of 7 to 16 meshes and the synthetic zeolite used is a granule-like marketed product having a particle size of 14 to 20 meshes.

An N₂-diluted mixture gas of ClF₃, Cl₂ and SiF₄ was passed at a gas flow rate of 1.3 L/min and an LV (Linear velocity) of 104 cm/min at room temperature in the following order: first through Fe₂O₃ (Example 1) or synthetic zeolite (Example 2), at the first stage, and then through the anion exchange resin at the second stage. The gas concentrations of ClF₃, Cl₂ and SiF₄ at the inlet were 0.21%, 0.38% and 0.25%, respectively.

The gas was passed until any of ClF₃, Cl₂ and SiF₄ had a concentration exceeding its acceptable level at the outlet of the second stage with the anion exchange resin and finally leaked. Further, treatment tests were conducted for Comparative Examples 1 and 2 under the same conditions as in Examples 1 and 2 except that the anion exchange resin used as a packed bed at the second stage was Sample No. 6. The results obtained are shown in Table 2.

TABLE 2
Results in Examples

| | Packed bed at | Packed bed at 2nd | Treatment | Breakthrough |
|---|---|---|---|---|
| | 1st stage | stage | time (min) | component |
| Ex. 1 | Fe₂O₃ | Anion exchange | 270 | Cl₂ |
| | | resin No. 1 | | |
| Ex. 2 | Synthetic | Anion exchange | 410 | Cl₂ |
| | zeolite | resin No. 1 | | |
| Comp. | Fe₂O₃ | Anion exchange | 190 | Cl₂ |
| Ex. 1 | | resin No. 6 | | |
| Comp. | Synthetic | Anion exchange | 290 | Cl₂ |
| Ex. 2 | zeolite | resin No. 6 | | |

In both Examples 1 and 2, chlorine gas (Cl₂) is the first component that had a concentration exceeding its acceptable level and leaked. When the anion exchange resin with chlorine content of 10 mg/g or more was used, the treatment time was short by the time chlorine gas had a concentration exceeding its acceptable level first and leaked. From this result, the anion exchange resin with chlorine content of 10 mg/g or more could be confirmed to be unsuitable for actual operation.

[The Amount of the Residual Chlorine in the Regenerated Anion Exchange Resin]

One gram of used anion exchange resins having a skeleton comprising a styrene-divinylbenzene copolymer and a dimethylamino group attached to a benzene ring of the styrene moiety and divinylbenzene moiety of the copolymer wherein the used anion exchange resins adsorbed the halogenated gas, was washed with 0.5-5% NaOH solution and any of washing waters having different chlorine contents for 45 minutes at space velocity (SV) of 20-50 h⁻¹, and then dried at 100° C. for 6 hours to prepare three regenerated samples having water content of 5 w/w % or less and differed in chlorine content.

The results of measurement of the residual chlorine content in the anion exchange resins washed with washing water of differed chlorine concentration is shown in Table 3 and FIG. 4. FIG. 4 reveals that washing the used anion exchange resins with the washing water having chlorine content of 20 mg/L or less provides the regenerated anion exchange resins having the residual chlorine content of 10 mg/g or less.

TABLE 3
Relation between chlorine concentration in washing waters and residual
chlorine content in resins

| Chlorine concentration in | Residual chlorine content in |
|---|---|
| washing water (mg/L) | anion exchange resin (mg/g) |
| 7 | 7 |
| 20 | 10 |
| 50 | 85 |

What is claimed is:

1. A method for treating exhaust gas, comprising first contacting exhaust gas comprising inorganic halogenated gas discharged from sources of the exhaust gas with Fe₂O₃ or synthetic zeolite and then contacting the exhaust gas with an anion exchange resin having water content of 5 w/w % or less and halogen content of 10 mg/g or less.

2. The treatment method of claim 1, wherein the inorganic halogenated gas is chlorine trifluoride (ClF₃), silicon tetrahalide (SiX₄), boron trihalide (BX₃), phosphorus trihalide (PX₃), hydrogen halide (HX), or halogen gas (X₂) wherein X is a halogen atom.

3. The treatment method of claim 1, wherein the anion exchange resin is a weakly basic anion exchange resin.

4. The treatment method of claim 1, wherein the anion exchange resin that has adsorbed the inorganic halogenated gas is regenerated using an alkali aqueous solution and a washing water having residual chlorine content of 20 mg/L or less and is then reused.

5. An anion exchange resin having water content of 5 w/w % or less and halogen content of 10 mg/g or less.

6. The anion exchange resin of claim 5 having a skeleton comprising a styrene-divinylbenzene copolymer and an anion exchange group attached to a benzene ring of the styrene moiety and divinylbenzene moiety of the copolymer.

7. The anion exchange resin of claim 6, wherein the anion exchange group is an amino group represented by the following formula:
—N(R₁)(R₂) [Formula 1]
wherein each of R₁ and R₂, which may be the same or different, is a hydrogen atom or a C₁₋₆ alkyl group that may be substituted with an amino group(s) or a hydroxyl group(s).
